(19) United States
(12) Patent Application Publication
(10) Pub. No.: US 2005/0125264 A1
(43) Pub. Date: Jun. 9, 2005

(54) System and method for determining flight cancellations

(75) Inventors: Arnold H. Bramnick, Boca Raton, FL (US); J. Kendall Burch, Cooper City, FL (US); Lee E. Farnum, Fairfield, CT (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/730,847

(22) Filed: Dec. 9, 2003

(51) Int. Cl. G06F 17/60

(52) U.S. Cl. 705/5

(57) ABSTRACT

A method for determining flight cancellations includes the steps of obtaining flight financial data from at least one flight financial data store for at least two flight cancellation candidates. The flight financial data is processed for the flight cancellation candidates and the financial data for the flight cancellation candidates can be presented. The method further can include canceling at least one of the flight cancellation candidates based upon the presented financial data responsive to a user selection.

### BACKGROUND

1. Field of the Invention

This invention relates generally to commercial airline flight operation systems and methods, and more particularly to systems and methods for determining flight cancellations.

2. Background of the Invention

There are times in the commercial flight industry that flights must be cancelled. The reasons for cancellations vary, and can include aircraft mechanical problems, crew availability, weather conditions and the like. Cancellation decisions can be made based upon the affected flight, namely, in the case of a crew or mechanical problem, the flight to which the problem is directly associated is cancelled. Alternatively, equipment and crews can be redeployed so that the affected flight continues as scheduled and a different flight is cancelled or delayed. Financial considerations are sometimes taken into account in this decision process, however, the financial data that is used does not always provide useful or accurate information.

### SUMMARY OF THE INVENTION

A method for determining flight cancellations can include the steps of obtaining flight financial data from at least one flight financial data store for at least two flight cancellation candidates. The flight financial data is processed for the flight cancellation candidates and the financial data for the flight cancellation candidates can be presented. The method further can include canceling at least one of the flight cancellation candidates based upon the presented financial data.

The flight financial data can be any suitable data. In one aspect, the flight financial data can include, but is not limited to, cargo, United States Postal Service (USPS) mail, passenger ticket value and fuel requirements data. The flight financial data can be provided in substantially real time. The provision of real time data allows the cancellation decision to be made to optimize the financial return to the airline.

Flight operations data can also be utilized in the comparing step. The flight operations data can include crew and equipment considerations, as well as other flight operations considerations. The flight operation data can include cargo, crew, reservations, and other flight operations information. The flight operation data can be utilized to determine at least one flight cancellation candidate.

Another aspect of the present invention can include a method for determining flight cancellations. The method can include obtaining flight financial data from at least one flight financial data store for at least two flight cancellation candidates, comparing the flight financial data for the flight cancellation candidates, and canceling at least one of the flight cancellation candidates based upon the comparing step or providing the financial data to a flight operations controller as input to the human process of determining which flight to cancel.

A system for determining flight cancellations can include a flight financial data store and means for determining flight cancellation candidates. Means for comparing the flight financial data for the flight cancellation candidates can be included to determine at least one flight to be cancelled.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram for a system for determining flight cancellations according to one embodiment of the invention.

FIG. 2 is a depiction of an exemplary graphical user interface according to another embodiment of the invention.

FIG. 3 is a flow diagram illustrating a method according to yet another embodiment of the invention.

### DETAILED DESCRIPTION OF THE PREFERRED EMBODIMENTS

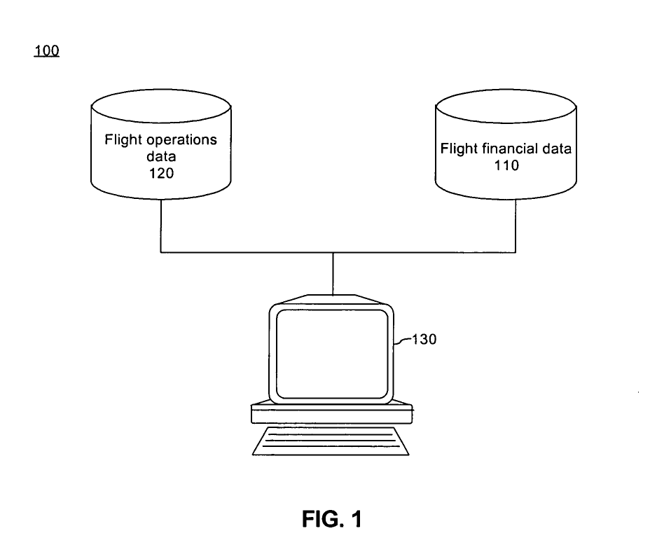

There is shown in FIG. 1 a system 100 in accordance with one embodiment of the invention. The system includes a flight financial data store 110 and a flight operations data store 120. At least one computer system 130 is provided for use by airline employees. The computer system 130 can include operational software configured to access the data stores 110 and 120 via suitable communications links and perform the various functions disclosed herein.

In one embodiment of the present invention, the computer system 130 can be a client system configured to access a server. The server can be configured to perform one or more of the functions described herein. For example, the computer system 130 can be implemented as a dumb terminal. According to another embodiment, the computer system 130 can include processing capability. For example, the computer system 130 can be a conventional computer system configured to perform one or more of the functions disclosed herein with or without the cooperation of a server.

The flight financial data store 110 can include any suitable flight financial data that provides the airline with a metric of flight value. This data can specify, without limitation, the value of passenger tickets, the value of cargo, the value of United States Postal Service (USPS) mail, and the associated costs with operating aircraft (cancellation candidates) including crew and fuel costs.

The flight operations data store 120 can include suitable flight operations data. The flight operations data can specify the availability of equipment, crew, airport gates, and the like. The flight operations data store 120 can be used in combination with the flight financial data store 110 to provide associated costs for each consideration. The information included in each respective data store can be specified on a per flight basis.

Although the flight financial data store 110 and the flight operations data store 120 are shown as single databases, data can be accumulated from several different databases or sources and these cumulative sources can be represented by the flight financial data store 110 and the flight operations data store 120. Also, the flight financial data store 110 and flight operations data store 120 could be combined in a single database or multiple databases. Further, while each data store is shown to be in close proximity to the computer system 130, it should be appreciated that the data stores can be disposed within the computer system 130 or can be located remotely from computer system 130 as well as one another.

The information obtained from the flight financial data store 110 and flight operations data store 120 can be presented to flight operations personnel through a graphical user interface (GUI) at one or more computer systems 130. The flight operations personnel can utilize this information to compare flight cancellation candidates and make a determination as to which flight to cancel. It is alternatively possible that a software program can be written to make this determination in an automated fashion, for example by automatically selecting the most cost effective flight to cancel.

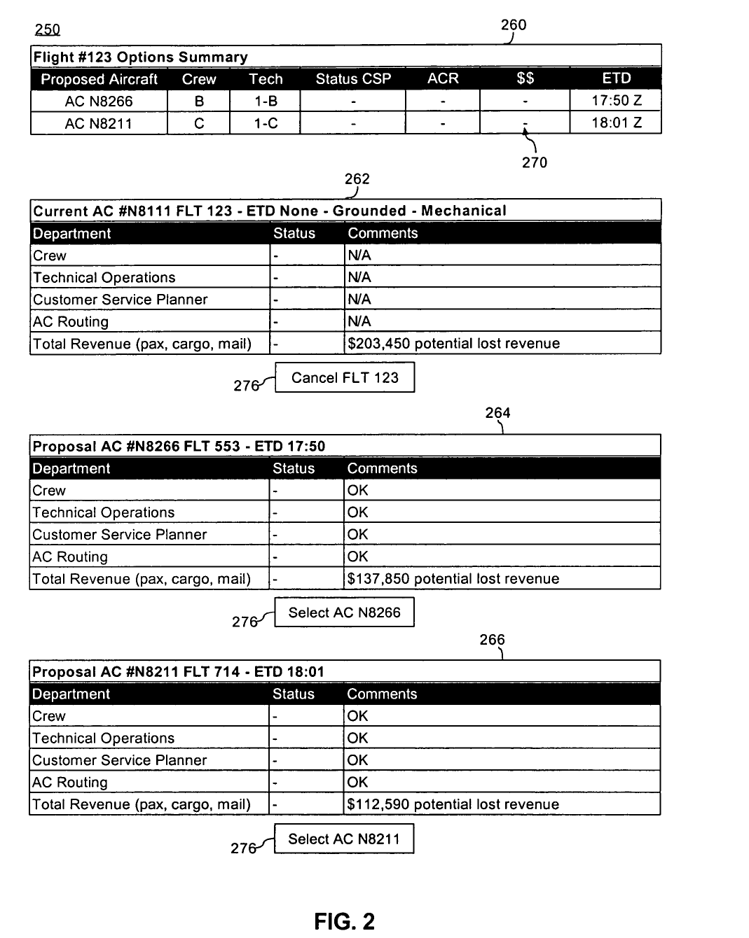

The information and manner of presentation to the flight operations personnel at the computer system 130 can be varied. An exemplary GUI 250 is shown in FIG. 2. The GUI includes a summary screen 260 utilized to facilitate the comparison of flight cancellation candidates. Also, detailed information for particular flight cancellation candidates can be shown in screens 262-266.

The following example is illustrative of the embodiment depicted in FIG. 2. Flight 123 is operating with an MD80 aircraft having tail number N8111 and is inbound to New York City (NYC). Flight 123 reports a warning light on the left engine. Upon landing, a determination is made that the engine needs to be repaired and the flight needs to be cancelled. Aircraft N8111, however, was scheduled to continue on an outbound flight to Miami (MIA) at 2:00 p.m.

Accordingly, flight operations personnel are presented with GUI 250. Comparison screen 260 shows two proposed aircraft, namely N8266 and N8211, that can be used in the place of N8111. The comparison screen 260 shows a comparison of flight financial data and flight operations data for each proposed aircraft. This data includes crew considerations, technical operations, customer service planner, aircraft routing (ACR) routing, and total revenue.

Flight crews typically are certified on different aircraft. Therefore, not every pilot is certified to fly every type of aircraft. Additionally, union contract and Federal Aviation Administration (FAA) regulations exist that determine the maximum number of hours that a crew can fly in a day or a month. These data points are taken into account when the crew management system determines whether or not a crew is available to fly an aircraft.

Technical operations refer to the ground crew required to load, fuel, and push back an aircraft. If no ground crew is available at a particular time to service an aircraft, that aircraft is not a viable option at that moment in time. Technical operations also can refer to the maintenance status of the aircraft.

Customer service planner refers to the availability of customer service personnel to be available to reaccommodate passengers on cancelled or delayed flights.

ACR controls the location of each aircraft. This is an issue in irregular operations when an aircraft is due for maintenance that must be performed within a certain period of time that continues to become smaller. For example, if the maintenance must be performed within twenty-four (24) hours and the maintenance base is in Tampa, Fla., the ACR personnel will not want that aircraft flown to China that day since at the end of the day the aircraft will not be at the required location for the maintenance.

Total revenue is the sum of the items on the aircraft that may be lost if the flight is cancelled. Total revenue can include, but is not limited to, time critical cargo and remaining coupon value for passengers on board.

Screen 260 also can include symbols 270. These symbols can be any of a variety of visual icons and/or can be color coded. For example, red can indicate that there is a significant problem in a particular area such as ACR for this aircraft to be used as a substitute. Yellow can indicate that there is some problem, but that a work around may be found. Green can indicate that there is little or no problem in selecting a particular aircraft.

Detailed views for each flight cancellation candidate are shown in screens 262-266. Each detailed screen 262-266 includes an indication of the potential lost revenue from the flight. For example, canceling the flight associated with aircraft N8266 as shown in screen 264 would result in a revenue loss of one hundred thirty-seven thousand eight hundred fifty dollars ($137,850.00). The net lost income for the continuation of flight 123, as shown in screen 262 is two hundred three thousand four hundred fifty dollars ($203,450.00) and the net lost income for canceling flight 714 to obtain the service of aircraft N8211 is one hundred twelve thousand five hundred ninety dollars ($112,590.00). It is apparent that the cancellation of the remainder of flight 714 would minimize the financial loss to the airline. Canceling the flight for proposed aircraft N8211 would result in a revenue loss of one hundred twelve thousand five hundred ninety dollars ($112,590.00). Canceling the flight associated with aircraft N8211 would result in a much reduced loss of revenue for the airline and, accordingly, the employee would select button 276 associated with screen 266.

The invention permits the airline employee to compare the relative value to the airline of canceling a flight other than flight 123 so that flight 123 can continue as scheduled. The determination is made in part on the basis of real time, or near real time, financial data made available by the invention to the airline employee. Previously, airline employees had little or no access to this data, and therefore, would estimate the loss of each flight to be the same and make the decision as to which flight to cancel based on other factors such as availability of crew, down time, and the like.

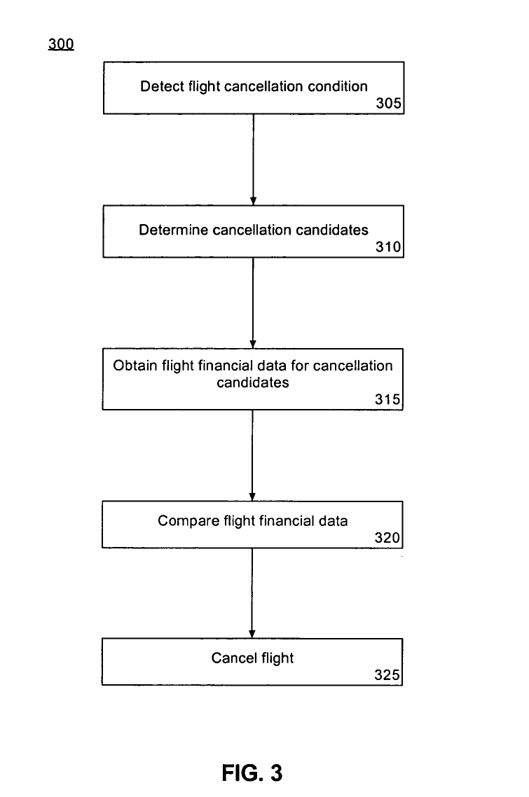

A method 300 according to another embodiment of the invention is shown in FIG. 3. The method can begin in step 305 in which a flight cancellation condition is detected. For example, a cancellation notification can be displayed upon an employee terminal or view screen. Cancellation candidates are determined in step 310. For example, one or more candidates can be determined by the airline system using flight operations data such as routing, type of aircraft, and any other pertinent considerations. In step 315, flight financial data can be obtained for the cancellation candidates.

The flight financial data can be compared or processed in step 320. For instance, if more than one type of financial data is obtained, each can be processed to determine a total financial outlook for canceling a flight. In illustration, financial data relating to values of passenger tickets, the value of cargo, the value of USPS mail, as well as any associated costs of operating the candidate aircraft including crew and fuel costs can be summed to determine an overall value for each cancellation candidate. The comparing/processing step can be accomplished by applying a set of predetermined operational rules to the flight financial data. Flight financial data for each cancellation candidate can be compared. Based upon the comparison, a flight is cancelled in step 325. That is, an employee operator can select a particular cancellation candidate in the presented GUI. Responsive to that selection, the chosen flight can be cancelled thereby freeing the associated aircraft for use by the airline.

As noted, however, the present invention can be automated such that either a cancellation candidate is automatically selected by the system or is suggested to an airline employee or system operator. For example, the cancellation candidate that would cost the airline the least amount of money to cancel can be cancelled automatically or highlighted in suggestion to a system operator.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for determining flight cancellations, comprising the steps of:
obtaining flight financial data from at least one flight financial data store for at least two flight cancellation candidates;
processing said flight financial data for said flight cancellation candidates; and
presenting the financial data for said flight cancellation candidates.

2. The method of claim 1, further comprising canceling at least one of said flight cancellation candidates based upon said presented financial data.

3. The method of claim 1, wherein said flight financial data comprises a value of at least one selected from the group consisting of cargo, United States Postal Service mail, passenger ticket, and fuel requirements data.

4. The method of claim 1, wherein said flight financial data is provided in substantially real time.

5. The method of claim 1, further comprising the step of obtaining flight operations data, said flight operations data being utilized by said obtaining step to determine flight cancellation candidates.

6. The method of claim 5, wherein said flight operations data comprises at least one selected from the group consisting of crew and plane availability data.

7. The method of claim 1, wherein said flight financial data store comprises at least one selected from the group consisting of cargo, crew, reservations, and flight operations information.

8. A method for determining flight cancellations, comprising the steps of:
obtaining flight financial data from at least one flight financial data store for at least two flight cancellation candidates;
comparing said flight financial data for said flight cancellation candidates; and
canceling at least one of said flight cancellation candidates based upon said comparing step.

9. A system for determining flight cancellations comprising means for storing flight financial data, means for determining flight cancellation candidates, and means for comparing said flight financial data for said flight cancellation candidates.

10. A system for determining flight cancellations comprising:
means for obtaining flight financial data from at least one flight financial data store for at least two flight cancellation candidates;
means for processing said flight financial data for said flight cancellation candidates; and
means for presenting the financial data for said flight cancellation candidates.

11. The system of claim 10, further comprising means for canceling at least one of said flight cancellation candidates based upon said presented financial data.

12. The system of claim 10, wherein said flight financial data comprises a value of at least one selected from the group consisting of cargo, United States Postal Service mail, ticket, and fuel requirements data.

13. The system of claim 10, wherein said flight financial data is provided in substantially real time.

14. The system of claim 10, further comprising means for obtaining flight operations data, said flight operations data being utilized by said means for obtaining flight financial data to determine flight cancellation candidates.

15. The system of claim 14, wherein said flight operations data comprises at least one selected from the group consisting of crew and plane availability data.

16. The system of claim 10, wherein said flight financial data store comprises at least one selected from the group consisting of cargo, crew, reservations, and flight operations information.

17. A system for determining flight cancellations, comprising:
means for obtaining flight financial data from at least one flight financial data store for at least two flight cancellation candidates;
means for comparing said flight financial data for said flight cancellation candidates; and
means for canceling at least one of said flight cancellation candidates based upon a determination from said means for comparing.

18. A machine readable storage, having stored thereon a computer program having a plurality of code sections executable by a machine for causing the machine to perform the steps of:
obtaining flight financial data from at least one flight financial data store for at least two flight cancellation candidates;
processing said flight financial data for said flight cancellation candidates; and
presenting the financial data for said flight cancellation candidates.

19. The machine readable storage of claim 18, further comprising canceling at least one of said flight cancellation candidates based upon said presented financial data.

20. The machine readable storage of claim 18, wherein said flight financial data comprises a value of at least one selected from the group consisting of cargo, United States Postal Service mail, ticket, and fuel requirements data.

21. The machine readable storage of claim 18, wherein said flight financial data is provided in substantially real time.

22. The machine readable storage of claim 18, further comprising the step of obtaining flight operations data, said flight operations data being utilized by said obtaining step to determine flight cancellation candidates.

23. The machine readable storage of claim 22, wherein said flight operations data comprises at least one selected from the group consisting of crew and plane availability data.

24. The machine readable storage of claim 18, wherein said flight financial data store comprises at least one selected from the group consisting of cargo, crew, reservations, and flight operations information.

25. A machine readable storage, having stored thereon a computer program having a plurality of code sections executable by a machine for causing the machine to perform the steps of:
obtaining flight financial data from at least one flight financial data store for at least two flight cancellation candidates;
comparing said flight financial data for said flight cancellation candidates; and
canceling at least one of said flight cancellation candidates based upon said comparing step.
